(19) United States
(12) Patent Application Publication
(10) Pub. No.: US 2016/0110767 A1
(43) Pub. Date: Apr. 21, 2016

(54) COUPON PROVIDER

(71) Applicant: Yahoo!, Inc., Sunnyvale, CA (US)

(72) Inventors: Eric Bax, Altadena, CA (US); John Peng, Burbank, CA (US); Mark Abraham, Camarillo, CA (US); Roxana Iuliana Marcu Forbes, Encino, CA (US); Tomaso Pozzi, San Francisco, CA (US)

(21) Appl. No.: 14/519,858

(22) Filed: Oct. 21, 2014

(51) Int. Cl. G06Q 30/02; G06Q 50/00

(52) U.S. Cl. CPC G06Q 30/0256; G06Q 50/01

(57) ABSTRACT

One or more methods and/or techniques for coupon providing is provided herein. A user, of a client device, may search for an entity (e.g., a consumer product and/or service). The entity may be associated with a domain (e.g., a business that offers the entity for purchase). An advertisement associated with the entity and/or the domain may be identified. A coupon associated with the advertisement for the domain may be identified. The coupon may be applicable to the entity. The advertisement and the coupon may be provided on a webpage.

### BACKGROUND

When a user on a client device is searching for an entity (e.g., a consumer product, such as running shoes, and/or a service, such as personal training), the user may be directed to a domain (e.g., a business that offers the entity for purchase, such as a shoe store that sells the running shoes or a gym that offers personal training). After identifying the domain, the user may spend extensive amounts of time and/or computing resources searching for coupons that may be applicable to the entity and/or domain (e.g., a running shoe coupon, a coupon code for the shoe store, etc.). The user may find coupons that are expired, that are relevant to the domain but not the entity (e.g., an orthotics coupon for the shoe store), etc. If the user does not find an applicable coupon, then the user may forgo purchasing the entity from the domain.

### SUMMARY

In accordance with the present disclosure, a query may be evaluated to identify an entity. The entity may comprise at least one of a consumer product identifier (e.g., a blue dress) or a service identifier (e.g., a manicure). A domain associated with an advertisement that corresponds to the entity may be identified. A business may be identified as the domain based upon the entity being available for purchase from the business (e.g., a Dress Shop that sells the blue dress). A coupon for the domain may be identified based upon the advertisement (e.g., 20% off of dresses coupon for the Dress Shop).

The advertisement and the coupon may be provided (e.g., on a search engine results page for the query). The search engine results page may include a search result comprising the advertisement and a coupon interface element for the coupon. Responsive to a selection of the coupon interface element, an interactive coupon interface may be displayed. The interactive coupon interface may comprise a coupon code, a copy option, a coupon code success notification, a coupon code instruction, a social media share option, user coupon comments, and/or a print coupon option.

Responsive to the selection of the coupon interface element, the coupon code may be presented. A copy option for the coupon code may be presented with the coupon code. A paste option may be presented with the coupon code. The paste option may include a mechanism to insert the coupon code into a promotional interface associated with a checkout webpage for one or more entities associated with the coupon. A notification that the coupon code will be applied at the checkout webpage, for the purchase of the entity, may be presented with the coupon code. A share option for sharing the coupon through a social network may be presented with the coupon code.

Interaction information regarding user interaction with the coupon may be collected. The interaction information may be utilized to determine whether to subsequently associate the coupon with the advertisement and/or to facilitate an advertisement sale of the advertisement and/or a coupon sale of the coupon.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of providing a coupon for an advertisement.

FIG. 5A is a component block diagram illustrating an example system for providing a coupon for an advertisement.

FIG. 5B is a component block diagram illustrating an example system for providing a coupon for an advertisement, where the coupon is selected.

FIG. 5C is a component block diagram illustrating an example system for providing a coupon for an advertisement, where the coupon is selected.

FIG. 6 is a component block diagram illustrating an example system for providing a coupon for an advertisement, where the advertisement associated with a coupon and a second advertisement associated with a second coupon are provided.

FIG. 7 is a component block diagram illustrating an example system for providing a coupon for an advertisement, where the coupon is shared via social media.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

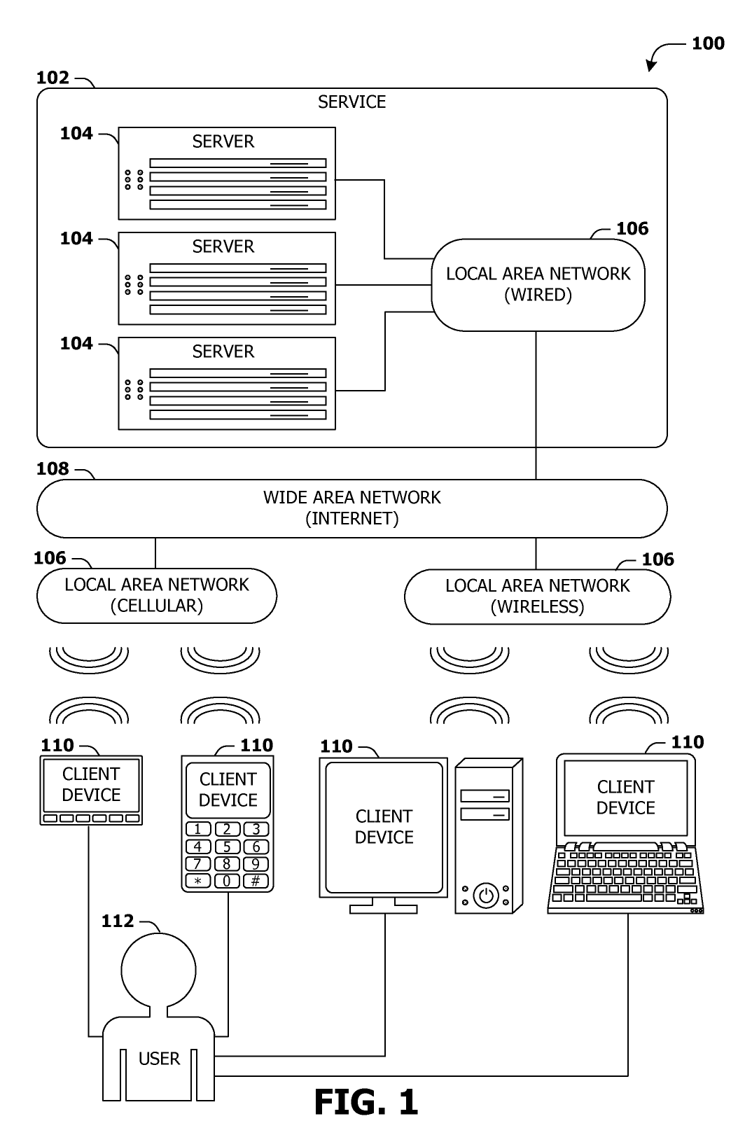

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

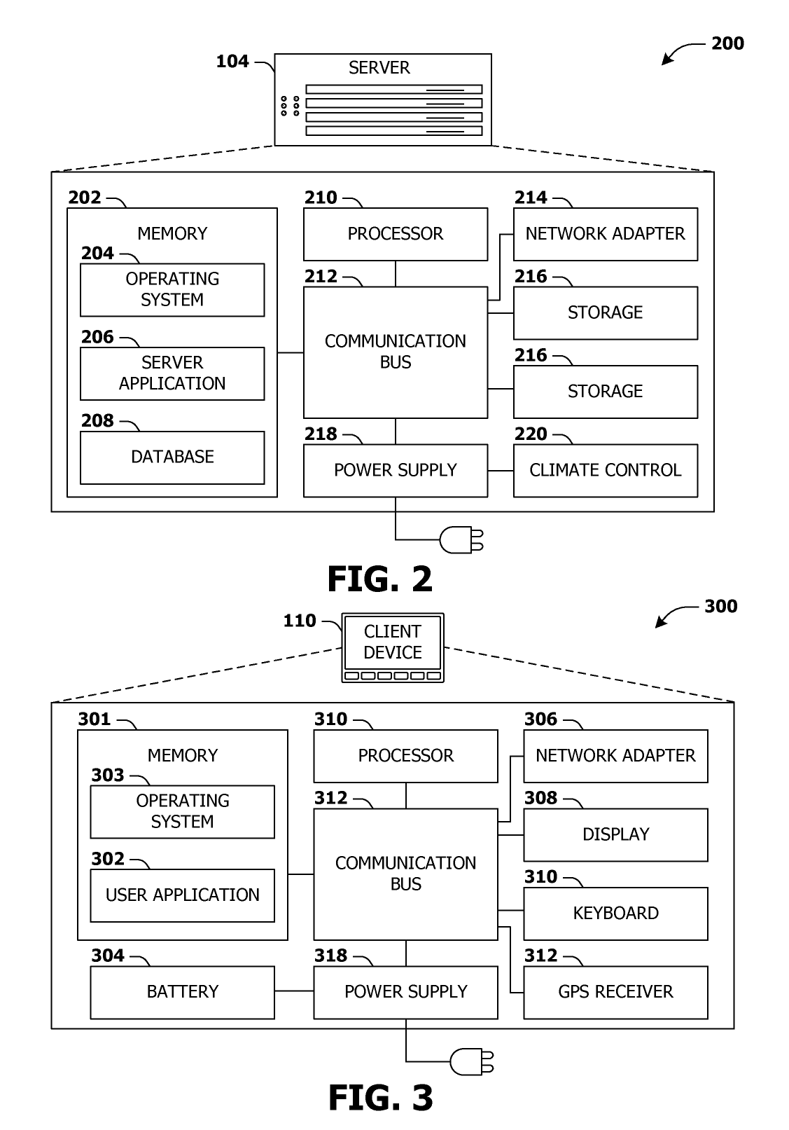

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for providing a coupon for an advertisement are provided herein. A user on a client device may search for an entity (e.g., a consumer product, such as dog collar, and/or a service, such as pet training), which may direct the user to a domain (e.g., a business that offers the entity for purchase, such as a Pet Store). The user may, after identifying the domain, search for coupons that would be usable at the domain and/or that are applicable to the entity. The coupon may offer a discount on a purchase price of the entity. Accordingly, as provided herein, coupons associated with an entity and/or a domain that sells the entity may be identified from an advertisement of the domain, and the coupons may be provided to a user having an interest in the entity, which may mitigate computing resources, such as battery power consumption, processing resources, and/or bandwidth, otherwise wasted by the user in performing multiple searches to identify relevant coupons (e.g., the user may merely locate expired coupons, a coupon for the Pet Store but not the dog collar or pet training, etc.).

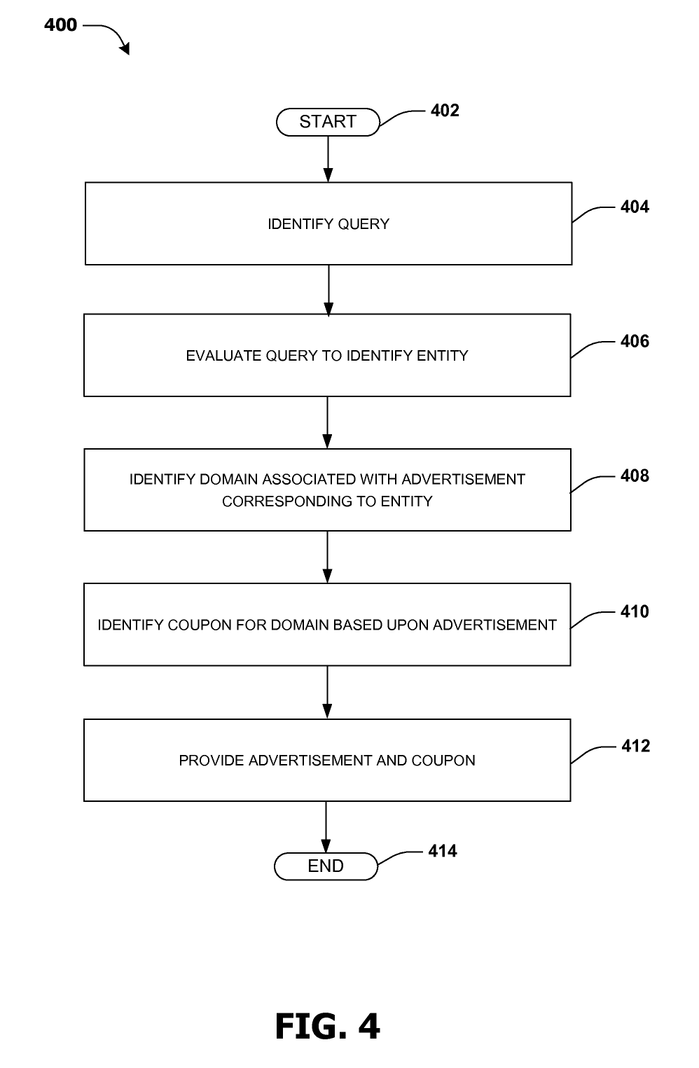

An embodiment of providing a coupon for an advertisement is illustrated by an example method 400 of FIG. 4. At 402, the method 400 starts. At 404, a query may be identified. A user on a client device may enter the query into a query area of a webpage, such as a search page of a search website. For example, the user may submit a query “pumpkin spice facial treatments” or a query “find red shoes” to the search website.

At 406, the query may be evaluated to identify an entity. The entity may comprise a consumer product identifier (e.g. red high heeled shoes) and/or a service identifier (e.g., a pumpkin spice facial service). The entity may be associated with a type. In an example, if the entity is “red high heeled shoes,” then the type may be identified as women's shoes. In an example, if the entity is “pumpkin spice facial,” then the type may be spa services.

At 408, a domain associated with an advertisement that corresponds to the entity may be identified. The domain may comprise a business that offers the entity for purchase. In an example, the domain may be a Shoe Store that sells women's shoes. In another example, the domain may be a Spa that offers spa services such as facials. The domain may be identified by performing a domain search using the type and/or the entity. The domain search may identify the advertisement (e.g., women's shoes for sale or spa services for sale). The advertisement may be associated with the domain (e.g., if the domain is the Shoe Store, then the Shoe Store may have the advertisement for women's shoes). The domain search may be performed on a first database comprising one or more domains associated with one or more advertisements. In an example, if the domain is the Spa, then the Spa may have the advertisement offering pumpkin spice facials.

At 410, a coupon for the domain may be identified based upon the advertisement. In an example, a coupon search may be performed to identify the coupon. For example, the advertisement, the entity, the domain, and/or the type may be used for the coupon search to identify the coupon (e.g., a search of a coupon database, a web or internet search, a search of a domain website hosted by the domain, etc.). In an example, user information (e.g., information that is available about the user), and/or one or more portions of the query may be used for the coupon search to identify the coupon. In an example, the coupon search may be performed on a second database comprising one or more coupons. For example, the coupon search may comprise “Shoe Store,” “women's shoes,” and/or “red high heeled shoes.” The coupon may comprise a discount on the entity, (e.g., 20% off women's shoes, $20 off high heels, etc.).

At 412, the advertisement and the coupon may be provided. In an example, a webpage may display the advertisement and a coupon interface element for the coupon. The webpage may comprise any webpage on which an advertisement may appear. In an example, if the user is searching for a location, and the search generates a hotel advertisement for a hotel at that location, then the coupon may be provided with the hotel advertisement. In an example, if the user is searching for an image, and the search generates an image advertisement for an image that is displayed, then the coupon may be provided with the image advertisement. The webpage may comprise a search engine results page, a social network interface, an email application, a calendar application, a mobile app, and/or an application.

In an example, the user may select the coupon interface element. Responsive to the selection of the coupon interface element, an interactive coupon interface may be displayed. The interactive coupon interface may comprise a coupon code, a copy option, a coupon code success notification, a coupon code instruction, a share option, user coupon comments, and/or a print coupon option.

Responsive to the selection of the coupon interface element, the coupon code may be presented. The copy option for the coupon code may be presented with the coupon code (e.g., the copy option may correspond to a copy function of an operating system such that a paste function of the operating system may be used to paste the coupon code into a content field, such as an email, a text box, etc.). A paste option may be presented with the coupon code. The paste option may include a mechanism to insert the coupon code into a promotional interface associated with a checkout webpage for one or more entities associated with the coupon. A notification that the coupon code will be applied at a checkout webpage for a purchase associated with the coupon may be presented with the coupon code. A share option for sharing the coupon through a social network may be presented with the coupon code. At 414, the method 400 ends.

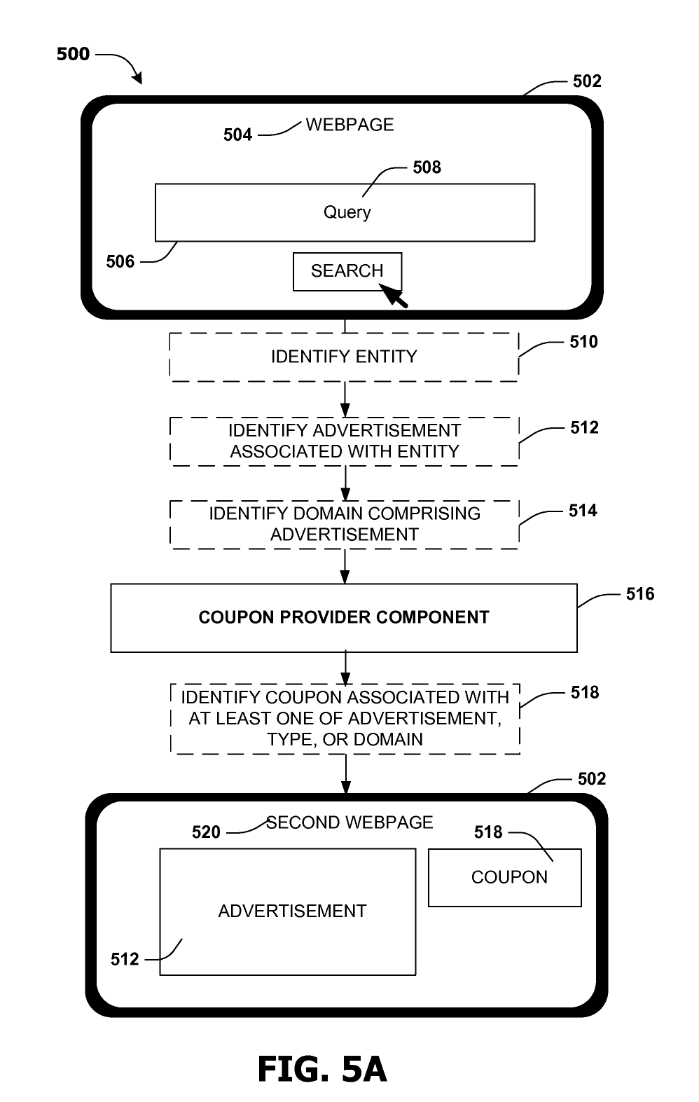

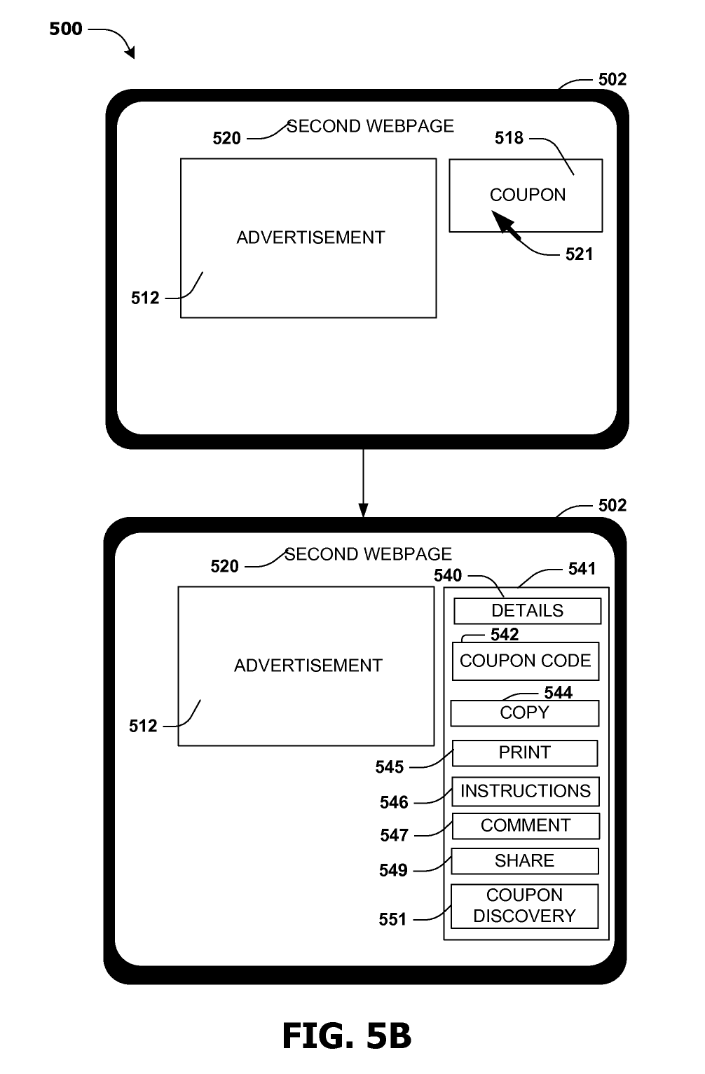

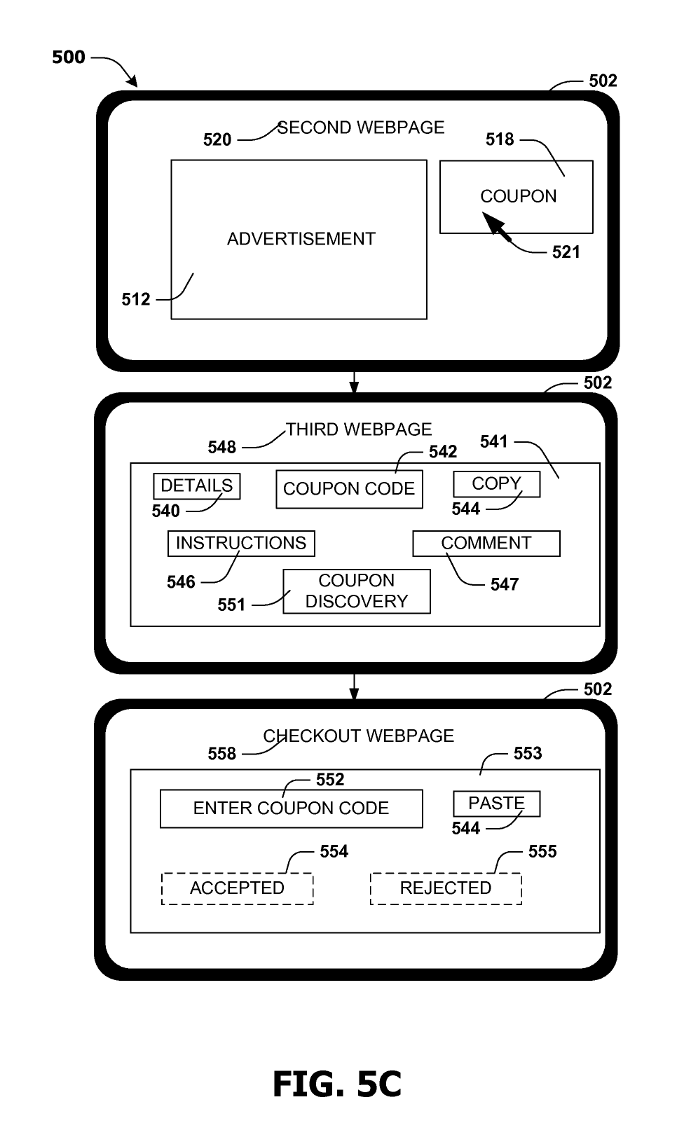

FIGS. 5A-5C illustrate a system 500, comprising a coupon provider component 516 for providing a coupon 518 associated with an advertisement 512. FIG. 5A illustrates the coupon provider component 516 providing the coupon 518 associated with the advertisement 512. A user on a client device 502 may input a query 508 into a query box 506 of a webpage 504. The query 508 may comprise an entity 510. The coupon provider component 516 may identify the entity 510. The entity 510 may comprise a consumer product identifier (e.g., running shorts) and/or a service identifier (e.g., roof installation). A type of the entity 510 may be identified. In an example, if the entity 510 comprises running shorts, then the type may be athletic apparel. In an example, if the entity 510 comprises roof installation, then the type may be construction and/or roofing.

The coupon provider component 516 may identify the advertisement 512 associated with the entity 510 and/or the type. The advertisement 512 may comprise an offer of sale of the entity 510 (e.g., if the entity 510 comprises athletic shorts, then the advertisement 512 may comprise an offer for sale of athletic shorts, athletic apparel, and/or apparel). The coupon provider component 516 may identify a domain 514 comprising the advertisement 512.

The domain 514 may comprise a business that offers the entity 510 for purchase. For example, responsive to the advertisement 512 comprising the offer for sale of athletic shorts, the domain 514 may comprise a Sports Store. The Sports Store may sell athletic apparel. For example, responsive to the advertisement 512 comprising the offer for the service of roofing, the domain 514 may comprise a Roof Store. The Roof Store may be a business that builds and/or repairs roofs.

The coupon provider component 516 may identify the coupon 518 associated with at least one of the advertisement 512, the type, and/or the domain 514. The coupon provider component 516 may identify the coupon 518 based on a search comprising the advertisement 512. In an example, the search may comprise the domain 514, the type, and/or the entity 510. The coupon 518 may be applicable to the entity 510 offered for sale by the advertisement 512. In an example, where the advertisement 512 comprises the offer for sale of athletic shorts and the domain 514 comprises the Sports Store, the coupon 518 may be offer 10% off a purchase of athletic apparel from the Sports Store. In an example where the advertisement 512 comprises the offer for the service of roofing and the domain 514 comprises the Roof Store, the coupon 518 may offer 25% off roof installation from the Roof Store.

The coupon provider component 516 may provide the advertisement 512 and the coupon 518 on a second webpage 520 on the client device 502. The second webpage 520 may comprise a search results webpage. One or more coupons may be provided with the advertisement 512 on the second webpage 520.

FIG. 5B illustrates a first graphical interface configuration providing the advertisement 512 and the coupon 518. The coupon 518 may comprise a coupon interface element. The coupon interface element may comprise a mechanism to access additional information about the coupon 518. Responsive to a selection 521 of the coupon 518, an interactive coupon interface 541 may be displayed on the second webpage 520 with the advertisement 512. The interactive coupon interface 541 may comprise details 540 about the coupon 518, a coupon code 542, a copy option 544 for the coupon code 542, a print option 545 for the coupon code 542, instructions 546 about how to use and/or redeem the coupon 518, a comment mechanism 547 for the coupon 518 (e.g., the user may comment about the reliability, effectiveness, etc., of the coupon 518, which may be provided to other users), a coupon discovery component 551, and/or a share mechanism 549 to share the coupon 518 on social media.

The details 540 may specify that the coupon 518 corresponds to a percentage off of a purchase price of the entity 510, a set amount of money off of a purchase of the entity 510, etc. The coupon code 542 may comprise an alpha and/or numeric code. The coupon code 542 may comprise a barcode, a radio frequency (RF) code, a quick response (QR) code, and/or a near-field communicator. The copy option 544 may be invoked to save the coupon code 542 for future use, such as when the user selects a paste option (not shown). The print option 545 may be invoked to print the coupon code 542 on a piece of paper and/or write the coupon code 542 onto a digital document. The instructions 546 may include a series of one or more actions that the user may take to apply and/or redeem the coupon 518. For example, the instructions 546 may comprise an instruction to take a first action comprising “copy the coupon 518 and/or the coupon code 542,” take a second action comprising “select the advertisement 512,” and/or take a third action comprising “apply the coupon 518 at the checkout page during the purchase of the entity 510.” The coupon discovery component 551 may include an option to see more coupons associated with the domain 514, an option to see more coupons associated the type and/or the entity 510, an option to see trending coupons (e.g., coupons that have been popular, such as measured by a number of users selecting the coupon, over a period of time, such as a week, a month, etc.), and/or an option to see all coupons (e.g., the user may be directed to a separate webpage that comprises a search mechanism for more coupons).

FIG. 5C illustrates a second graphical interface configuration providing the advertisement 512 and the coupon 518. The coupon 518 may comprise the coupon interface element. The coupon interface element may comprise the mechanism to access additional information about the coupon 518. Responsive to the selection 521 of the coupon 518, the interactive coupon interface 541 may be displayed on a third webpage 548 that may not contain the advertisement 512. The interactive coupon interface 541 may comprise the details 540, the coupon code 542, the copy option 544, the print option 545 (as shown in FIG. 5B, above), the instructions 546, the comment mechanism 547, the coupon discovery component 551, and/or the share mechanism 549 (as shown in FIG. 5B, above).

The coupon code 542 may be applied at a check out webpage 558, such as when the user is purchasing the entity 510 from the domain 514. The checkout webpage 558 may comprise a promotional interface 553. The promotional interface 553 may comprise a prompt to enter coupon codes 552, a paste option 544, and/or an indication that the coupon code 542 has been accepted 554 or denied 555. Selection of the paste option 544 may retrieve the coupon code 542 (e.g., based upon the user previously using the copy option 554 to copy the coupon code 542). Upon retrieval of the coupon code 542, the checkout webpage 558 may present a coupon code successes notification, which may comprise the accepted 554 notice, to indicate that the coupon code 542 was successfully applied and/or the coupon 518 was redeemed with regard to the entity 510. If the coupon code 542 was unsuccessfully applied and/or the coupon 518 was not redeemed with regard to the entity 510, then the rejected 555 notice may be displayed. In an example, the comment mechanism 547 may be used by the user to provide user feedback for the coupon 518, such as whether the coupon 518 was successful or rejected.

Interaction information about the coupon 518 may be collected to determine whether the coupon 518 and the advertisement 512 may be associated in future searches. Responsive to the coupon being rejected 555 with regards to the entity 510, the coupon provider component 516 may not present the coupon 518 with the advertisement 512 in response to a second query comprising the entity 510.

A value of showing a coupon 518 may be determined based on interaction information. The value may be adjusted to account for longer-term effects on user behavior (e.g., the likelihood of the user returning to a website comprising the webpage 504 and/or the second webpage 520). The value of showing the coupon 518 may determine a frequency that the coupon 518 is provided (.e.g., if the coupon 518 has a first value and a second coupon has a second value, both the coupon 518 and the second coupon are for the same domain 514 and/or entity, and the first value is higher than the second value, then the coupon 518 may be displayed with greater frequency than the second coupon). For example, if receiving the coupon 518 indicates that the user may be more likely to increase his/her use of the website comprising the webpage 504 and/or the second webpage 520, then the value of showing the coupon 518 may be increased. In an example, if the coupon 518 has a good success rate (e.g., more than 50% of users of the coupon 518 receive the coupon success notification) the coupon provider component may increase the value of showing the coupon 518, and thus display the coupon 518 with more frequency than the second coupon that has a lower success rate.

The coupon code 542 may applied at a checkout of the domain 514 (e.g., where the user is physically present in the business), by providing the alpha and/or numeric code, the RF code, the QR code, or the near-field communicator to a cashier of the coupon code 542. The coupon code 542 may be presented on the client device 502 and/or on a piece of paper on which the coupon code 542 is printed. In an example, where the coupon code 542 comprises the QR code, the coupon code 542 may be scanned by a QR scanner at the domain 514. In an example, where the coupon code 542 comprises the alpha and/or numeric code, the coupon code 542 may be entered into a checkout machine at the domain 514.

An owner/operator of the website comprising the webpage 504, and/or the second webpage 520 may offer space for sale on one or more webpages of the website. Businesses, such as the domain 514, may purchase the space to display one or more advertisements. Coupon suppliers may purchase the space to display one or more coupons. A price of the space may depend on interaction information (.e.g., user interaction with at least one of the advertisement 512 and/or the coupon 518). For example, the offer for space may specify that the domain 514 pays the owner/operator when the user clicks on the advertisement 512. In an example, the offer for space to a coupon-supplier may specify that the coupon supplier pays the owner operator when the user uses the coupon code 542 to complete a sale. In an example, if the coupon 518 increases the likelihood of users' using the website, the price for the space of the coupon 518 may be reduced.

The price of the space may be adjusted based upon whether the advertisement 512 is provided with or without the coupon 518. Providing the advertisement 512 with the coupon 518 may make displaying the advertisement 512 more and/or less valuable to the domain 514 For example, if the coupon 518 makes it more likely that the user will complete a sale, and if an expected profit increases for the domain 514 with the reduced price from the user using the coupon 518, then the providing the coupon 518 with the advertisement 512 may be more valuable to the domain 514 For example, if the coupon 518 makes it less likely that the user will complete the sale, and/or if the expected profit decreases for the domain 514 with the reduced price from the user using the coupon 518, then the providing the coupon 518 with the advertisement 512 may be less valuable to the domain 514 The price of the space may be adjusted either by the domain 514, by the owner/operator, or automatically by the website based upon whether providing the advertisement 512 and the coupon 518 increases or decreases the value to the domain 514 (e.g., the price may increase where the value increases, or decrease where the value decreases). In an example, if providing the advertisement 512 and the coupon 518 increases the value to the domain 514 and if providing a second advertisement and the second coupon decreases the value to the domain 514, then the coupon 518 and the advertisement 512 may be provided, but merely one of the second advertisement or the second coupon may be provided.

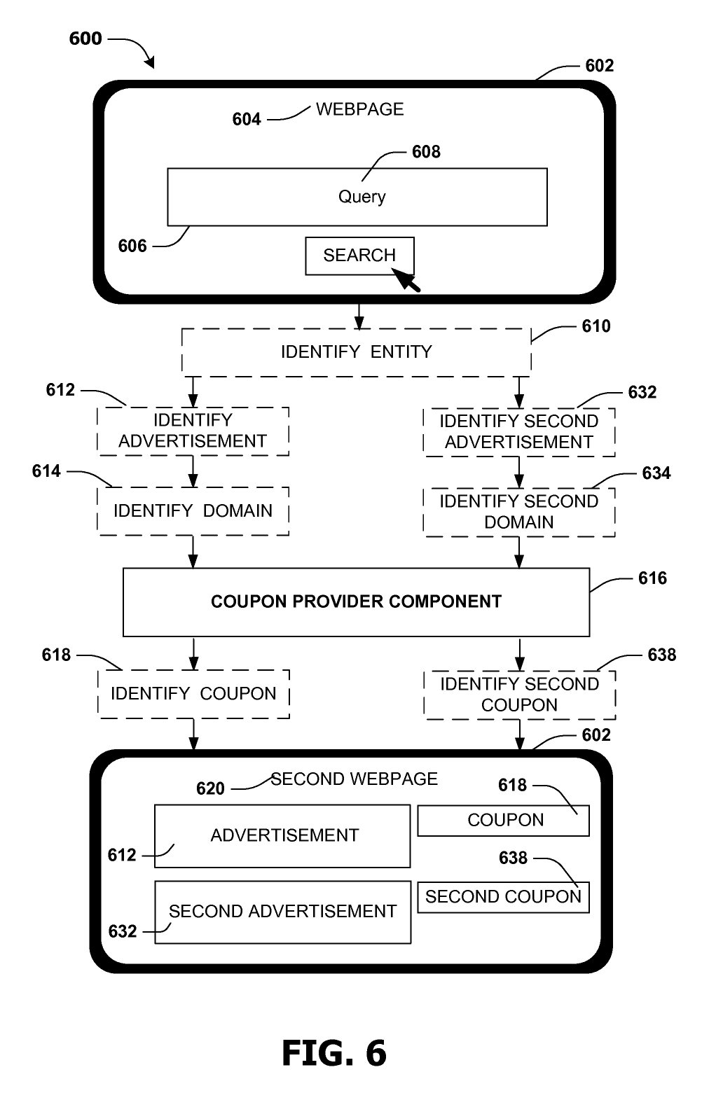

FIG. 6 illustrates a coupon provider component 616 providing a coupon 618 associated with an advertisement 612 and a second coupon 638 associated with a second advertisement 632. A user on a client device 602 may input a query 608 into a query box 606 of a webpage 604. The query 608 may comprise an entity 610. The coupon provider component 616 may identify the entity 610. The entity 610 may comprise a consumer product identifier (e.g., chocolate bar) and/or a service identifier (e.g., clothing alterations). A type of the entity 610 may be identified. In an example where the entity 610 comprises chocolate bar, the type may be candy. In an example where the entity 610 comprises clothing alterations, the type may be tailoring.

The coupon provider component 616 may identify the advertisement 612 and the second advertisement 632 associated with the entity 610 and/or the type. The advertisement 612 and the second advertisement 632 may comprise offers of sale of the entity 610. The coupon provider component 616 may identify a domain 614 associated with the advertisement 612 and a second domain 634 associated with the second advertisement 632.

The domain 614 and/or the second domain 634 may comprise a business that sells the entity 610. For example, the domain 614 may be a First Candy Store that sells chocolate bars and the second domain 634 may be a Second Candy Store that sells chocolate bars. The coupon provider component 616 may identify the coupon 618 associated with the advertisement 612 and the second coupon 638 associated with the second advertisements 632. The coupon provider component 616 may identify the coupon 618 based on a coupon search comprising the advertisement 612. In an example, the coupon search may utilize the domain 614, the type, and/or the entity 610. The coupon provider component 616 may identify the second coupon 638 based on a second coupon search comprising the second advertisement 632. In an example, the second coupon search may utilize the second domain 634, the type, and/or the entity 610.

The coupon 618 may be applicable to the entity 610 offered for sale by the advertisement 612. The second coupon 638 may be applicable to the entity 610 offered for sale by the second advertisement 632. For example, responsive to the advertisement 612 comprising the offer for sale of chocolate bars by the domain 614 of the First Candy Store, the coupon 618 may offer 10% off a purchase of candy bars from the First Candy Store. Responsive to the second advertisement 632 comprising the offer for sale of chocolate bars by the second domain 634 of the Second Candy Store, the second coupon 638 may offer 15% off a purchase of candy bars from the Second Candy Store. The coupon provider component 616 may provide the advertisement 612 with the coupon 618, and the second advertisement 632 with the second coupon 638 on a second webpage 620 accessed by the client device 602.

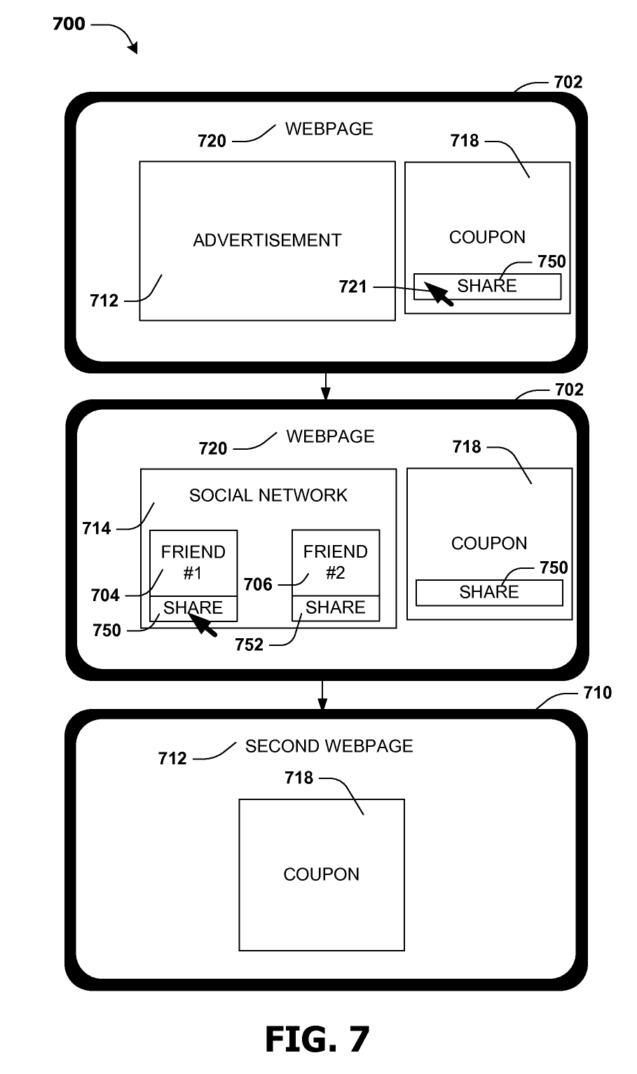

FIG. 7 illustrates a system 700, comprising presenting a coupon 718 with an advertisement 712, where a share option 750 is selected 721. The advertisement 712 and the coupon 718 may be provided on a webpage 720 on a client device 702. The user may select 721 the share option 750. The selection 721 of the share option 721 may display friends (e.g., members associated with the user) of a social network 714 (e.g., a social network in which the user is a member). A friend #1 704 may be displayed on the webpage 720, or on a separate webpage. The friend #1 704 may be associated with a first share option 750. A friend #2 706 may be displayed on the webpage 720, or on a separate webpage. The friend #2 706 may be associated with a second share option 752. The user may search for a specific friend (not shown) on the social network 714. The specific friend may be associated with a third share option (not shown). Responsive to the user selecting Friend #1 704, the coupon 718 may be presented to the friend #1 704 on a second webpage 712 on a second client device 710. Responsive to the user selecting Friend #2 706, the coupon 718 may be presented to the friend #2 706 (e.g., a social network message of the coupon 718 may be sent to the friend #2 706, the coupon 718 may be posted to a social network profile of the friend #2 706, etc.).

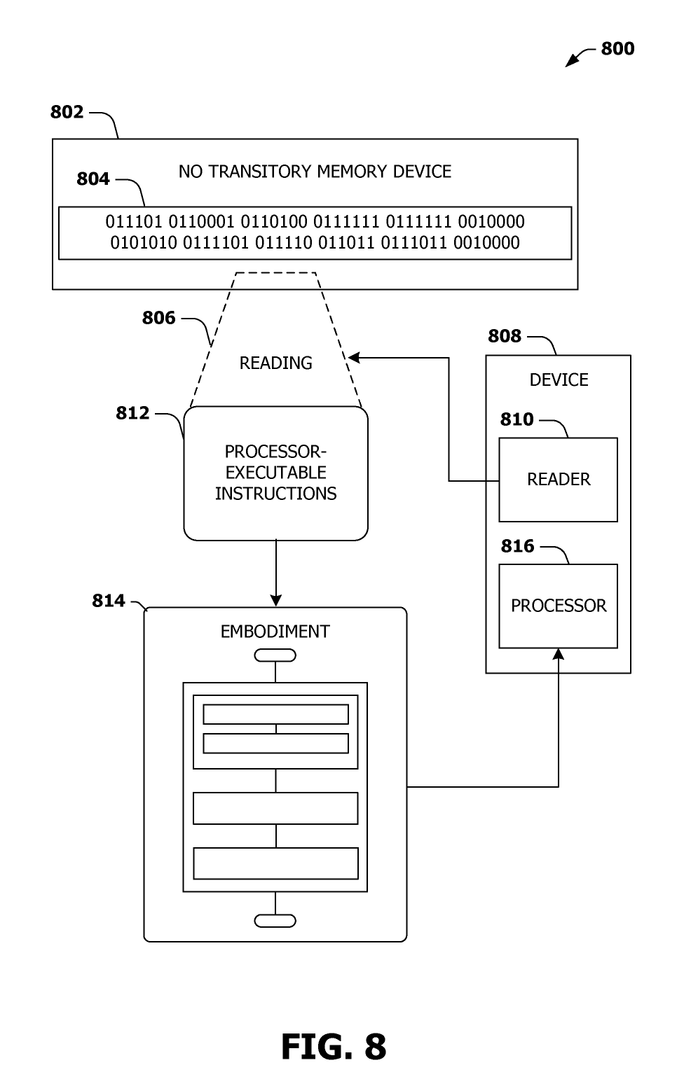

FIG. 8 is an illustration of a scenario 800 involving an example nontransitory memory device 802. The nontransitory memory device 802 may comprise instructions that when executed perform at least some of the provisions herein. The nontransitory memory device 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example method 400 of FIG. 4, for example. In some embodiments, the processor-executable instructions, when executed on the processor 816 of the device 808, are configured to implement a system, such as at least some of the example system 500 of FIGS. 5A-5C, at least some of the example system 600 of FIG. 6, and/or at least some of the example system 700 of FIG. 7 for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of providing a coupon for an advertisement, comprising:
evaluating a query to identify an entity, the entity comprising at least one of a consumer product identifier or a service identifier;
identifying a domain associated with an advertisement corresponding to the entity;
identifying a coupon for the domain based upon the advertisement; and
providing the advertisement and the coupon.

2. The method of claim 1, the identifying a domain comprising:
identifying a business as the domain based upon the entity being available for purchase from the business.

3. The method of claim 1, comprising:
generating a search engine results page for the query; and
including a search result, comprising the advertisement and a coupon interface element for the coupon, within the search engine results page.

4. The method of claim 3, comprising:
responsive to a selection of the coupon interface element, displaying an interactive coupon interface comprising at least one of a coupon code, a copy option, a coupon code success notification, a coupon code instruction, a share option, user coupon comments, a coupon discovery component, or a print coupon option.

5. The method of claim 1, the providing comprising:
presenting a coupon code responsive to a user selecting the coupon.

6. The method of claim 5, the presenting a coupon code comprising:
presenting a copy option for the coupon code; and
presenting a paste option to insert the coupon code into a promotional interface associated with a checkout webpage for one or more entities associated with the coupon.

7. The method of claim 5, the presenting a coupon code comprising:
presenting a notification that the coupon code will be applied at a checkout webpage responsive to a purchase of the entity associated with the coupon.

8. The method of claim 5, the presenting a coupon code comprising:
presenting at least one of a barcode, a radio frequency (RF) code, a quick response (QR) code, or a near-field communicator.

9. The method of claim 1, comprising:
collecting interaction information regarding user interaction with the coupon; and
utilizing the interaction information to determine at least one of:
whether to subsequently associate the coupon with the advertisement; or
whether to increase or decrease a cost to purchase a space for at least one of the advertisement or the coupon.

10. The method of claim 1, comprising at least one of:
presenting a share option for sharing the coupon through a social network; or
presenting a coupon discovery component.

11. A system for providing a coupon for an advertisement, comprising:
a coupon provider component configured to:
evaluate a query to identify an entity, the entity comprising at least one of a consumer product or a service identifier;
identify a domain that provides an advertisement associated with the entity;
identify a coupon for the domain based upon the advertisement; and
provide the advertisement and the coupon.

12. The system of claim 11, the coupon provider component configured to:
present a copy option for the coupon code; and
present a paste option to insert the coupon code into a promotional interface associated with a checkout webpage for one or more entities associated with the coupon.

13. The system of claim 11, the coupon provider component configured to:
present a notification that the coupon code will be applied at a checkout webpage responsive to a purchase of an entity associated with the coupon.

14. The system of claim 11, the coupon provider component configured to:
generate a search results page for the query; and
include a search result, comprising the advertisement and a coupon interface element for the coupon, within the search results page.

15. The system of claim 11, the coupon provider component configured to:
present at least one of a barcode, a radio frequency (RF) code, a quick response (QR) code, or a near-field communicator comprising the coupon code.

16. The system of claim 11, the coupon provider component configured to:
collect interaction information regarding user interaction with the coupon; and
utilize the interaction information to facilitate at least one of an advertisement sale or a coupon sale.

17. The system of claim 11, the coupon provider component configured to at least one of:
present a share option for sharing the coupon through a social network; or
present a coupon discovery component.

18. A non-transitory computer readable medium comprising computer executable instructions that when executed by a processor perform a method for providing a coupon for an advertisement, comprising:
identifying an advertisement, of an entity, provided through an interface;
identifying a domain associated with the entity;
identifying a coupon for the domain; and
providing the coupon through the interface.

19. The method of claim 18, the interface comprising at least one of a search engine results page, a social network interface, an email application, a calendar application, a mobile app, or an application.

20. The method of claim 18, comprising:
providing the coupon as a coupon interface element; and
responsive to a selection of the coupon interface element, displaying an interactive coupon interface comprising at least one of a coupon code, a copy option, a coupon code success notification, a coupon code instruction, a share option, user coupon comments, an coupon discovery component, or a print coupon option.
